(19) United States
(12) Patent Application Publication
(10) Pub. No.: US 2011/0274508 A1
(43) Pub. Date: Nov. 10, 2011

(54) METAL SHAVING AND SLUG COLLECTOR

(76) Inventor: Bobby L. Russell, Concord, NC (US)

(21) Appl. No.: 13/093,450

(22) Filed: Apr. 25, 2011

Related U.S. Application Data
(60) Provisional application No. 61/327,306, filed on Apr. 23, 2010.

(51) Int. Cl. B23B 47/34

(52) U.S. Cl. 408/67

(57) ABSTRACT

Disclosed are tools and related methods for collecting metal shavings and slugs which are produced when cutting access holes into a surface.

### CROSS REFERENCE To RELATED APPLICATIONS

This application claims priority and incorporates entirely by reference U.S. Provisional Patent Application Ser. No. 61/327,306 filed on Apr. 23, 2010, listing Bobby L. Russell as the inventor and entitled “METAL SHAVING AND SLUG COLLECTOR.”

### FIELD OF THE INVENTION

The present invention relates to tools and related methods for collecting metal shavings and slugs which are produced when cutting access holes into a surface.

### BACKGROUND

Hole saws are utilized to cut holes into surfaces. When cutting into a metal surface with a hole saw metal shavings and a slug are produced. The metal shavings and slugs pollute the work area. This is particularly problematic when cutting access holes into metallic boxes which contain electrical equipment. The metal debris can damage the electrical equipment and make the area dangerous for those working around the area.

Various methods have traditionally been utilized to collect metal shavings and slugs when using a hole saw to cut access holes. One method is simply to place a piece of cardboard under the area where the hole is to be cut so that the cardboard will catch the falling debris. This process is not a very effective method of collecting the debris as the cardboard may come dislodged or otherwise fail to collect all of the metal particles.

Another method of collecting metal shavings and slugs when cutting access holes with a hole saw involves the use of a cylindrical container which has magnets around the rim at the open end of the container. The magnets are utilized to hold the container in place on the underside of a metallic surface into which the access hole will be cut. A hole saw may then be used to cut an access hole within the interior diameter of the rim of the container attached to the underside of the surface. If the hole is properly cut within the interior diameter of the container, the container will catch the falling debris while remaining adhered to the surface. This method also has disadvantages. The container device does not act as a guide for the hole saw or the hole saw pilot drill. Therefore, the user is not assured that the hole will be properly cut and that the debris will properly fall into the container. Further, debris may collect on the top of the surface as the hole is cut. The debris will contaminate the work area and potentially fall into the access hole once the container is removed. The debris may also adhere to the sides of the container making it difficult to easily clean the metal particles from the inside of the container.

Therefore, there is a need for more efficient tools and methods that improve the collection of metal shavings and slugs when cutting access holes.

### SUMMARY OF THE INVENTION

Accordingly, in one aspect, the present invention is a tool for collecting metal shavings and slugs which are produced when cutting access holes with a hole saw.

In an exemplary embodiment, the collector tool includes a magnetized bottom cup with a pilot drill guide (i.e., to facilitate placement of the hole). The magnetized bottom cup may be attached underneath a surface to be cut. The bottom cup may also include a tether to ensure that the cup does not become separated from the surface (i.e., to prevent the cup from falling and damaging electrical or other equipment). The collection tool may further include a removable lining insert that sits within the cup (i.e., to facilitate collection and removal of the metal shavings and slugs from the cup).

The exemplary collector tool also includes a magnetized top cylinder which attaches to the top of the surface to be cut. The top cylinder is an open cylinder (i.e., a cylinder which does not have a top or bottom). The top cylinder includes an internal magnetized ring to adhere metal debris which may be scattered toward the top surface (i.e., to facilitate collection and removal of the metal shavings from the top cylinder).

In a related aspect, the present invention is a safer and more efficient method for cutting access holes with a hole saw using the aforementioned collector tool.

The foregoing, as well as other objectives and advantages of the invention and the manner in which the same are accomplished, are further specified within the following detailed description and its accompanying figures.

### BRIEF DESCRIPTION OF THE DRAWINGS

FIG. 1 is a perspective view of an unassembled exemplary collector tool according to the present invention.

FIG. 2 is a perspective view of an assembled exemplary collector tool according to the present invention.

FIG. 3 is a side view of the exemplary collector tool according to the present invention attached to a surface.

FIG. 4 is a sectional view of the top cylinder portion of the exemplary collector tool according to the present invention.

FIG. 5 is a sectional view of the bottom cup portion of the exemplary collector tool according to the present invention.

FIG. 6 is a perspective view of the pilot drill guide of the exemplary collector tool of the present invention.

FIG. 7 is a perspective view of a second embodiment of the exemplary collector tool of the present invention which includes magnets around the rim of the bottom cup.

FIG. 8 is a perspective view of the bottom cup portion of the exemplary collector tool of the present invention.

FIG. 9 is a perspective view of the bottom cup portion of the second embodiment of the exemplary collector tool of the present invention with a removable lining insert.

FIG. 10 is an elevation view of a metal slug shaving collector having an edge that is shaped to fit about a pipe or other conduit.

### DETAILED DESCRIPTION

The present collector tool facilitates collecting metal shavings and slugs which are produced when cutting access holes into a surface with a hole saw.

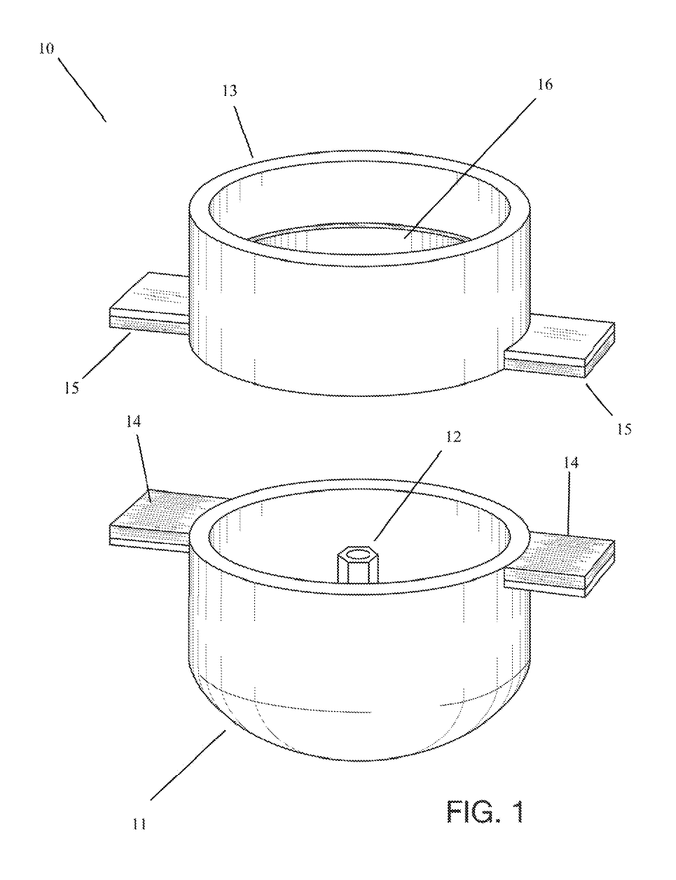

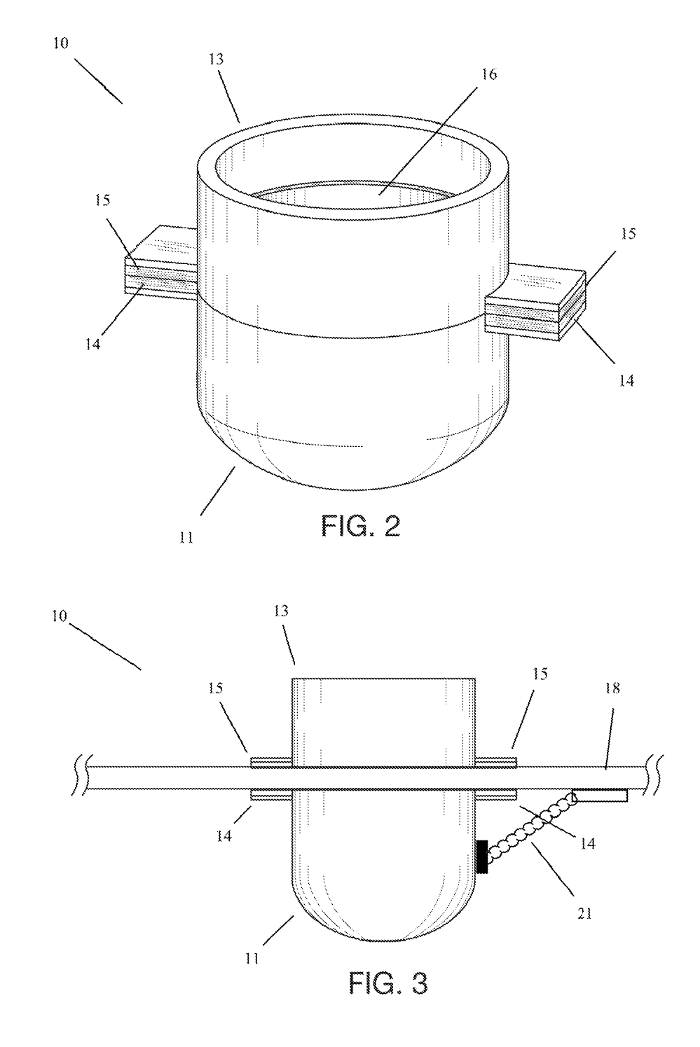

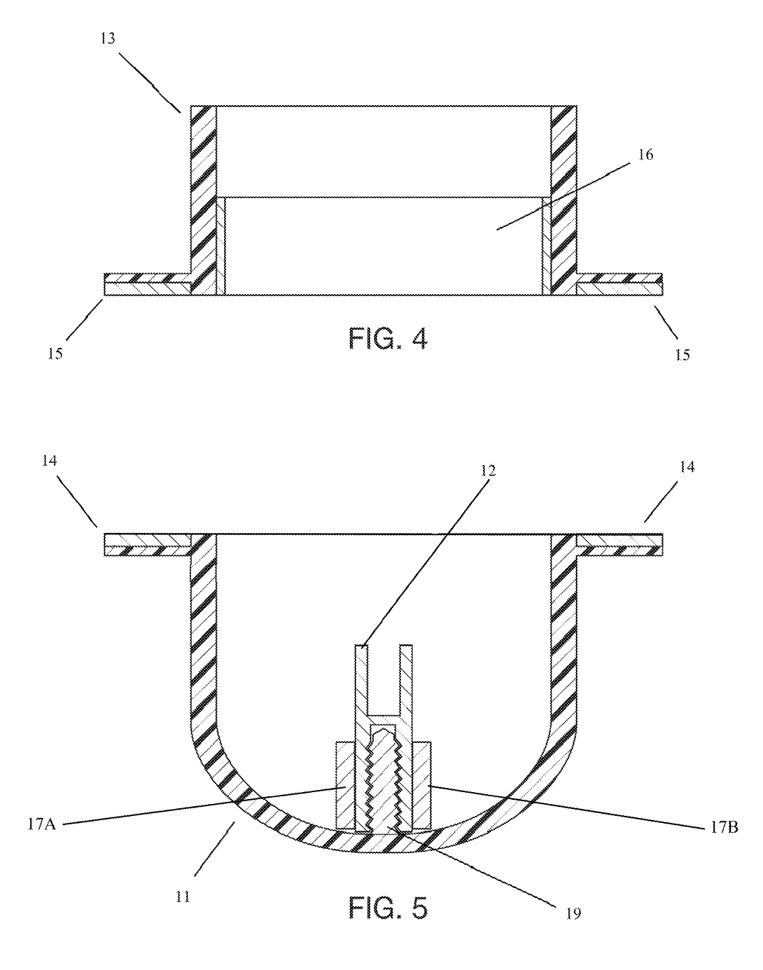

As depicted in FIGS. 1-5, the exemplary collector tool (10) includes a bottom cup (11) and a top cylinder (13).

The bottom cup (11) includes a pilot drill guide (12) for receiving the pilot drill bit of a hole saw. The pilot drill guide (12) may be inserted into the bottom cup (11) and secured in place by a screw (19) (FIG. 5). Those having ordinary skill in the art will appreciate that the pilot drill guide (12) may be secured to the bottom cup (11) using other techniques well known within the art to temporarily or permanently secure the pilot drill guide (12) into the bottom cup (11).

The bottom cup (11) may also include a tether (21) (FIG. 3) to ensure that the cup (11) does not accidently become separated from the surface (18) and damage underlying electrical or other equipment. The tether (21) may be a chain, as depicted, or any other type of material of sufficient strength to support the weight of the bottom cup. The tether (21) may be temporarily attached to the surface (18) through the use of a magnet and permanently attached to the bottom cup (11) by a screw. Those having ordinary skill in the art will appreciate that the tether (21) may be temporarily and/or permanently secured to the bottom cup (11) and surface (18) using other techniques well known within the art to temporarily or permanently secure the tether (12) between the surface (18) and the bottom cup (11).

In the first exemplary embodiment depicted in FIGS. 1-5 and 8 the bottom cup (11) and the top cylinder (13) each include two sets of magnets; bottom cup magnets (14) and top cylinder magnets (15).

The top cylinder (13) includes a magnetic ring (16) (FIGS. 1, 2, and 4) which facilitates collection and removal of metal shavings from the top cylinder (13) which may collect on the top of the surface as the hole is cut.

The top cylinder (13) and the corresponding bottom cup (11) of the exemplary collector tool (10) may be appropriately sized and packaged to match a typical set of hole saws. Thus, when a particularly sized access hole is desired, a corresponding collector tool size would be chosen to accomplish the job. A smaller sized bottom cup more suitable for smaller sized access holes is depicted in FIG. 8.

As depicted in FIGS. 1-5 and 8, in the first exemplary embodiment the bottom cup magnets (14) and the top cylinder magnets (15) extend from opposing surfaces across respective diameters of the bottom cup (11) and top cylinder (13).

FIG. 5 shows an embodiment of the shaving collector in which the drill guide 12 is surrounded by magnets (17A, 17B) to pull the shavings down into the bottom cup (11). In this way, the shavings are automatically collected into the bottom cup (11) as they fall from the surface being drilled from above.

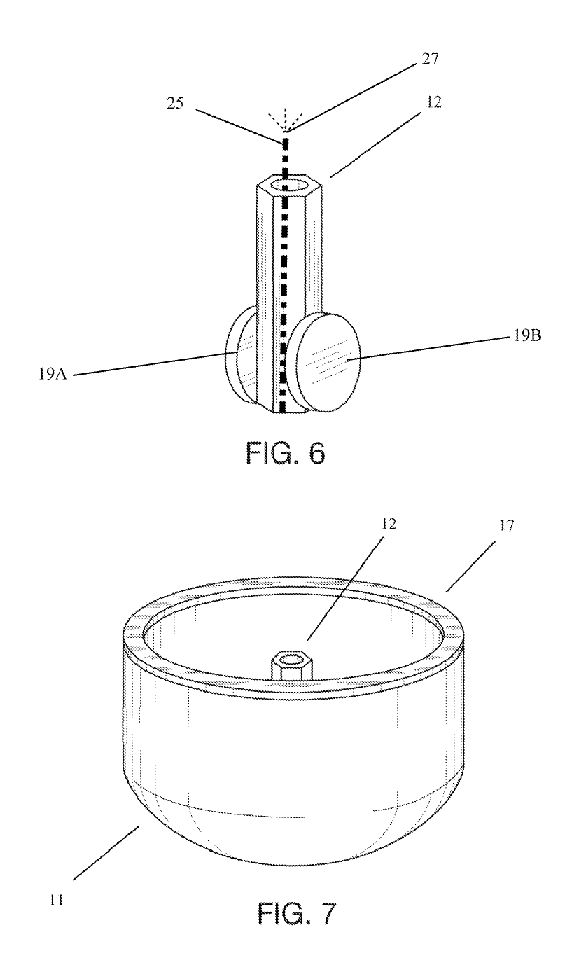

FIG. 6 is yet another embodiment of the shaving collector drill guide 12 that includes a fiber optic cable (25) extending through the drill guide. Again, the bottom cup magnets (19A, 19B) align alongside the drill guide 12. As shown in FIG. 6, the drill guide (12) may be a hollow cylindrically shaped device that allows the fiber optic cable (25) to pass there through. The fiber optic cable (25) can extend through and outside the bottom cup (11) or have access through the bottom cup (11) so that light can enter the fiber optic cable (25). Upon entering the fiber optic cable (25), the light traverses the length of the cable and illuminates the tip (27) of the fiber optic cable (25). The illuminated tip provides a better target for the user in drilling within dark surroundings.

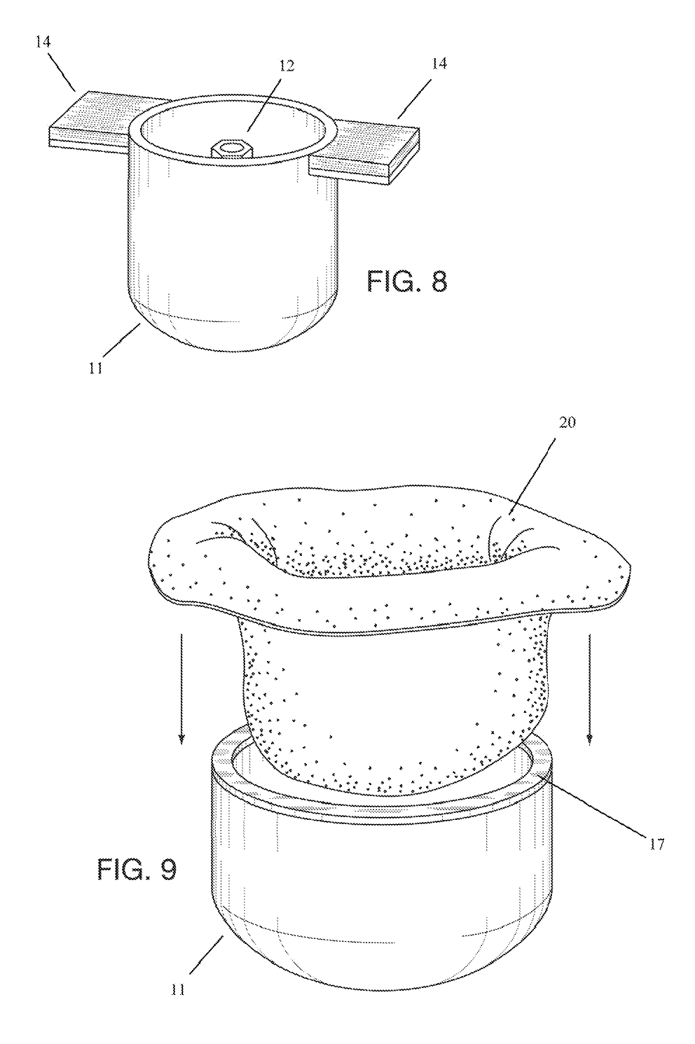

In a second exemplary embodiment, as depicted in FIG. 7, the bottom cup (11) may include a magnetic strip (17) along the rim of the cup. A corresponding magnetic strip may be provided along the lower rim portion of the top cylinder (not shown). Those having ordinary skill in the art will appreciate that the corresponding magnets in the bottom cup and the upper cylinder need not embrace any particular shape or pattern. Rather, the magnets ought to be of a type and position such that they are capable of providing sufficient attractive force between one another such that the collection tool may be properly attached to a surface (18) (FIG. 3).

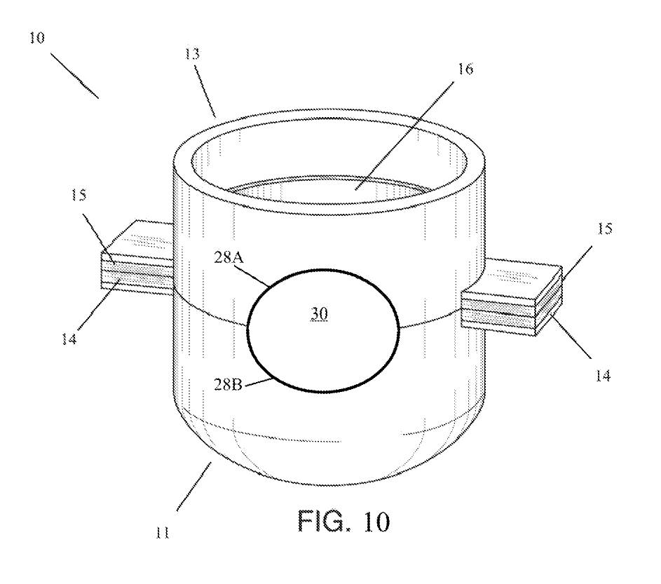

The second exemplary embodiment of the collector tool may further include a removable lining insert (20) that sits within the cup (FIG. 9). The removable lining insert (20) facilitates collection and removal of metal shavings and slugs from the cup making it easier to purge the metal particles from the inside of the cup.

The collector tool facilitates the safe and efficient cutting of access holes into surfaces, particularly into metallic boxes which contain electrical equipment. As noted above, metal debris can damage electrical equipment and make the area dangerous for those working around the area. Yet, when a hole saw is used with an appropriately sized collector tool, the top cylinder (13) and the pilot drill guide (12) serve to align the hole saw inside the interior of the diameter of the bottom cup (11). The bottom cup (11) will collect the falling metal shavings and slugs. The magnetic ring (16) will facilitate collection and removal of metal shavings from the top cylinder (13) which may collect on the top of the surface as the hole is cut.

FIG. 10 illustrates an embodiment of the shavings collector (11) with a different contour about its edges. The respective contoured edges (28A, 28B) on each of the top and bottom components (11, 13) allow the collector to fit about conduit and pipes of various shapes and sizes. In other words, when a surface to be drilled is part of a pipe, bar, conduit, or any surface having curvature, then the components (11, 13) fit snugly around that surface. The contoured edges (28A, 28B) may also have magnets thereon for better attachment.

The shavings collector described above is also amenable to use in environments outside the context of metals and magnets. For example, a shavings collector may be used in the context of drilling through sheet rock in a construction area. Instead of using magnets (17) about the rim of the top and bottom portions (11, 13), the sheet rock embodiment would use a removable putty that will hold the device in place. The putty would be easily removable from the sheet rock after use.

In the specification and/or figures, typical embodiments of the invention have been disclosed with respect to collecting metal shavings and slugs which are produced when cutting access holes into a surface. The present invention is not limited to such exemplary embodiments. Unless otherwise noted, specific terms have been used in a generic and descriptive sense and not for purposes of limitation.

1. A collection device for catching shavings emitted during a drilling operation, the collection device comprising:
a drill guide attached to a bottom portion of the collection device, said bottom portion for attaching to one side of a surface;
a shield for connecting to an opposite side of the surface, said shield having a perimeter, wherein a drill operates to form a hole in the surface within the perimeter.
